(19) United States
(12) Patent Application Publication
(10) Pub. No.: US 2007/0103766 A1
(43) Pub. Date: May 10, 2007

(54) Method for monitoring an optical transmission line by means of an optical amplifier and optical amplifier therefor

(76) Inventor: lars frriedrich, Munchen (DE)

Correspondence Address: Russell D Culbertson;The Culbertson Group, Suite 420, 1114 Lost Creek Boulevard, Austin, TX, 78746, US

(21) Appl. No.: 10/580,351

(22) PCT Filed: Oct. 26, 2005
(86) PCT No.: PCT/DE05/01924

§ 371 Date: May 23, 2006

(30) Foreign Application Priority Data
Oct. 26, 2004 (DE) 102044052150.6

(51) Int. Cl. H01S 3/00

(52) U.S. Cl. 359/341.1

(57) ABSTRACT

The invention relates to a method for monitoring an optical transmission line by means of an optical amplifier, in particular a Raman amplifier, wherein the pump power (Pₚ) generated by a pump source (13) of the optical amplifier (7) is coupled into the optical transmission line (9), wherein the power (P_{ASE}) of the ASE (Amplified Spontaneous Emission) signal generated by the pump power (Pₚ) in the transmission line (9) and fed back toward the optical amplifier (7) is detected, and wherein an error signal is generated when the power (P_{ASE}) of the detected ASE signal falls below a preset threshold value.

The invention relates to a method for monitoring an optical transmission line by means of an optical amplifier, in particular a Raman amplifier, and an optical amplifier suitable therefor.

For the transmission of optical signals across large distances, optical amplifiers are often used since they can be implemented with a lower degree of complexity than would be possible with a signal amplification by means of an optoelectric conversion of the signals, a purely electrical amplification and, possibly, signal conditioning, and a subsequent electrooptical conversion. An optical signal amplification is possible even in cases in which not only a signal with a single wavelength, but a wavelength multiplex signal is transmitted.

In addition to optical signal amplification by means of the so-called EDFA (Erbium-Doped Fiber Amplifier), it is possible to optically amplify a signal using the Raman effect. This latter possibility offers the advantage that it is not necessary to insert a specially designed fiber into the transmission line. The Raman effect, a nonlinear optical effect, also occurs when a sufficiently high pump power is coupled into conventional optical fibers. With fibers consisting primarily of silicon, the maximum optical amplification occurs at a frequency spacing of approximately 13 THz from the pump wavelength toward larger wavelengths. The slope of the amplification between the pump wavelength and the peak of the amplification is substantially linearly ascending.

When amplifiers that couple such a high pump power into the transmission line are used, it must be ensured that whenever the transmission line is opened up, either by disconnecting a plug-in connection or as a result of a broken optical fiber that transmits the signal, personnel is not at risk of injury as a result of the high optical power exiting from the transmission line.

If a transmission line is already in operation, an opening of the transmission line is, as a rule, monitored in a simple manner by detecting a signal loss. In this case, an LOS (loss of signal) signal is generated, which signal is subsequently used to switch off signal sources and potentially also pump sources or at least to decrease their power to a level at which they no longer pose a risk to persons or objects.

This approach for the protection of persons can, however, not be used if a communication connection does not yet exist between the end points of a transmission line. When establishing a communication connection, i.e., when activating the signal transmission sources and/or pump sources of optical amplifiers, it must, however, also be ensured that in cases of an open transmission line, no risk of injury arises as a result of the open end involved, which open end may be caused either by an unplugged plug or by a broken fiber. In this context, it is important to ensure that the requirements of laser safety classes are met.

To avoid such a risk in practical applications, it is, for example, known from US 2003/0179987 A1 that in the case of an optical wavelength division multiplex (WDM) transmission system, the pump power of a Raman pump can be coupled into the transmission line by means of a separate fiber just ahead of the transmission line by means of a bypass coupling unit. The optical transmission and reception signals, however, are carried by the actual receivers and transmitters via a separate rack which may, for example, comprise a patch panel. Such a patch panel serves to establish optical connections by inserting appropriate patch cables. Since plug-in connections on this patch panel are frequently disconnected and connected, the risk of also running the pump power through this patch panel would be high. In contrast, the use of a bypass fiber ensures markedly higher safety. Furthermore, the bypass coupling unit comprises sensors for detecting the pump power or the power of the WDM signal. Depending on certain situations, a control unit which analyzes the signals of the sensors can open and close shutters that are present in the WDM signal path and/or in the path of the pump signal. Similarly, after detecting a risky situation, the control unit can switch off the Raman pump.

This type of system, however, does not ensure the detection of situations in which the WDM signal transmission line is faulty between the two ends.

U.S. Pat. No. 6,621,620 B2 discloses an optical amplification system which detects an open transmission line, and once such a condition is detected, the pump source is deactivated. To detect an open transmission line, the signal which is, for example, reflected on open plug-in connections, i.e., disconnected plugs, or on smooth vertical bridges [sic; breaks] of a fiber is analyzed. Since the pump signal is, however, blocked by means of a filter, only the reflected signal which results from a reflection of the wanted signal can be detected.

Although such a system makes it possible to detect open plug-in connections or broken fibers, a defective communication connection is recognized only in those cases in which a sufficiently high signal power is reflected. This, however, is basically only the case if the end surfaces are sufficiently smooth and run perpendicular to the direction of propagation. Broken fibers with oblique or completely irregular end surfaces, however, cannot be detected, just as it is impossible to detect special connectors that have been obliquely ground to avoid Fresnel reflections.

Based on this prior art, the problem to be solved by the present invention is to create a method for monitoring an optical transmission line by means of an optical amplifier, in particular a Raman amplifier, which ensures reliable detection of those interruptions of a transmission line that generate, only extremely low if any, Fresnel reflections. In addition, the problem to be solved by this invention is to create an optical amplifier for implementing the method.

The invention solves this problem with the characteristics of Claims 1 and 11.

The invention is based on the realization that emission occurring spontaneously while the pump signal is being coupled into the transmission line as well as the ASE (Amplified Spontaneous Emission) signal caused thereby can be utilized to determine whether an interruption of the transmission line is present within the effective length of the transmission line in which, due to the sufficiently high pump power, a usable Raman amplification occurs. To this effect, a sufficiently high pump power is coupled into the transmission line, and the ASE signal that is fed back toward the pump source opposite to the direction of the propagation of the pump signal is detected. The power of this ASE signal which is nonlinearly dependent on the power of the pump source is determined and compared to a threshold value which, given the actual pump power, would be expected if the transmission line were undisturbed. If the power of the detected ASE signal is smaller than the preset threshold value, potentially allowing for a permissible tolerance limit, an error signal is generated. The error signal indicates that the transmission line has been interrupted or at least does not function properly.

In addition, the detected power of the ASE signal can be used to identify the approximate location of an interruption. For this purpose, the power of the detected ASE signal as a function of the length of the correctly operating transmission line can be used. If the pump power is known, the length of the transmission line up to the location of the interruption can be determined based on the power of the detected ASE signal as a function of the length of the correctly functioning transmission line, since the power of the detected ASE signal is known.

The error signal can be used to deactivate the pump source immediately after the error signal has been generated. Since the ASE signal is generated practically at the moment in which a sufficiently high pump power is present and can be detected practically without delay in time, the pump source can be deactivated fast enough that no risk of injury or damage arises in the location of the interruption of the transmission line.

Obviously, it is also possible to generate an optical or acoustic error message and/or an operator call.

The method according to the present invention is also especially suitable for monitoring an optical transmission line in the phase of starting up an optical amplifier, i.e., when the pump power is switched on. In the simplest case, the pump power can be immediately set to the maximum value or to a lower value which, however, must be high enough that the Raman effect still occurs, thus making it possible to detect an ASE signal. The latter-mentioned case of a pump power lower than the maximum value existing during the normal operation of the transmission line (said value can, of course, be lower than the value of the maximum pump power that can be generated by the pump), however, has the advantage that the power exiting from the free end on interruption of the transmission line is lower.

Obviously, the pump power can also be continuously increased or gradually increased step by step, and the power of the associated ASE signal at each incremental step can be detected. In this case, it is possible, for each “operating point” during the increase, to compare the determined power of the ASE signal with a corresponding threshold value. Each threshold value can be determined as described earlier either theoretically or by means of a calibrating procedure. As explained previously, the calibration is determined on the basis of the correctly functioning transmission line. Each threshold value can be saved and stored together with the associated pump power.

In cases in which several ASE signals are detected for various pump powers or that a continuous response of the ASE signal is determined for a continuously traversed range of the pump power, an error signal can be generated, for example, whenever the power of the associated ASE signal drops below the relevant threshold value, potentially allowing for a permissible tolerance limit, for the values detected for several or for all different values of the pump power. In this context, it is, of course, again conceivable to use mathematical methods or criteria which could be used to generate an error signal as a function of one or more values detected for the power of the ASE signal at each relevant pump power and as a function of theoretically or empirically determined threshold values or values to be expected for the power of the ASE signal when the transmission line is correct.

According to an embodiment of the present invention, in an upstream process step, the pump power can be set to a value at which nonlinear optical effects do not yet occur in the transmission line. Instead of the power of the ASE signal, it is then possible to detect the power of potentially occurring reflected signal components. As a preset threshold value is exceeded, a reflection error signal can be detected. This signal can also be used to completely deactivate the pump source and/or to generate an optical or acoustic error message or an operator call. If instead a reflection signal is generated, it is not necessary to increase the pump power to a value at which the Raman effect occurs and an ASE signal is generated. The reason is that in this case, because of the linear effect of the reflection, it can be assumed that the transmission line is disturbed.

According to the preferred embodiment of the present invention, the pump power of the optical amplifier is modulated, in particular amplitude-modulated. In this manner, it is possible to detect the ASE signal in a phase-sensitive manner, for example, by means of a lock-in amplifier. In this manner, it is possible to very accurately detect an ASE signal with very low power. As a result, the pump power must be initially set to a value that is only slightly higher than the value at which the Raman effect occurs. As a result, the risk of injury or damage in case of an open transmission line is reduced.

In this manner, it is possible to increase the pump power, optionally in several steps or continuously, while simultaneously detecting the ASE signal until the maximum value of the pump power desired for the operating of the transmission line has been reached. As a result, safety is increased. The reason is that with increasing pump power, the effective length of the transmission line, in which the power is high enough so that nonlinear effects occur, is increased. In cases in which an interruption of the transmission line is located beyond the effective length when the pump power is low, the ASE signal detected is still sufficiently high. In cases in which the location of the interruption is within the effective length when the pump power is increased, however, an interruption of the transmission line is detected.

The modulation of the pump power can also be handled in such a way that the time weighted average of the pump power is below a preset limit, e.g., by means of a pulse width modulation with an appropriate pulse duty factor (ON duration short compared to OFF duration). In this manner, in combination with the rapid reaction time up to the disconnection of the pump power after detection of an error signal, the safety is once again increased and, optionally, the requirements of a certain laser safety class are met.

Other embodiments of the invention follow from the dependent claims.

The invention will subsequently be described in greater detail based on a practical example shown in the drawing. As can be seen,

FIG. 1 shows a schematic representation of a WDM transmission line with an optical amplifier according to the present invention;

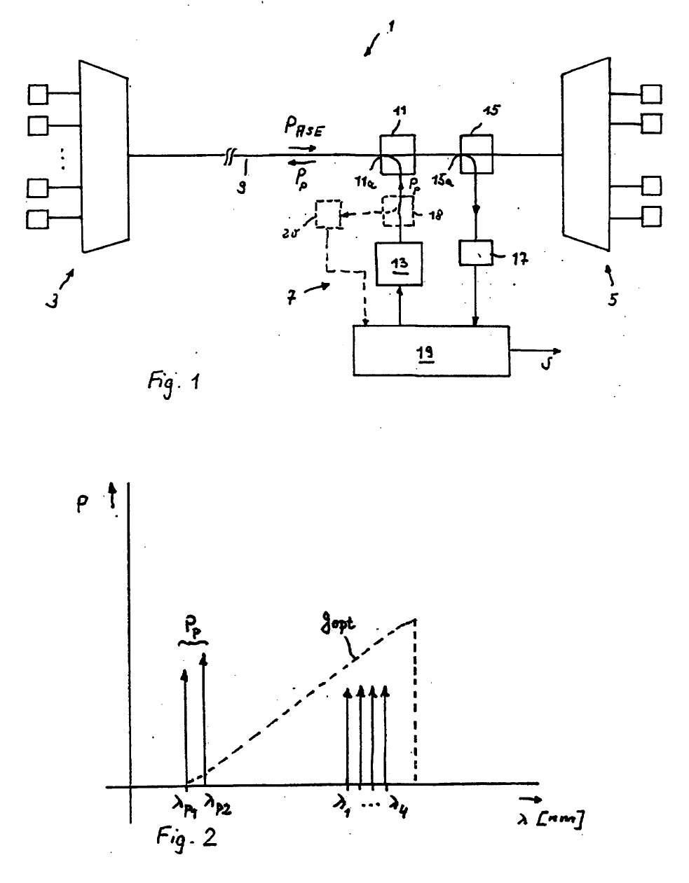

FIG. 2 shows a diagram with a schematic representation of the power that is coupled in the form of a WDM signal into the transmission line by a pump source or by a plurality of optical transmitters, and

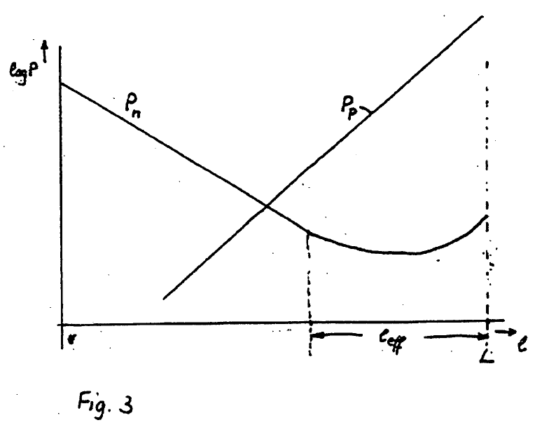

FIG. 3 shows a diagram that schematically illustrates the response of the power of the wanted signal and the response of the pump power over the length of the transmission line.

The WDM transmission system shown in FIG. 1 comprises a WDM transmitter unit 3 and a WDM receiver unit 5. To explain the present invention, for reasons of clarity, a unidirectional WDM transmission system is shown, without intending in any way to restrict the scope of invention to the exclusion of bidirectional transmission systems.

The WDM transmission system 1 furthermore comprises an optical amplifier unit 7 which preferably causes an optical amplification utilizing the Raman effect, but in any case couples a sufficiently high optical pump power into the transmission line 9 that the nonlinear Raman effect occurs. The optical amplifier unit 7 itself comprises a coupling unit 11, either in the form of a fused coupler or in the form of an integrated optics coupler. The pump power Pₚ of a pump source 13 is fed to the arm of the coupling unit 11 that is not located in the signal path of the transmission line 9. The pump source comprises, for example, a pump laser which releases the pump power at a specific pump wavelength λp. The pump source can, of course, also comprise two or more pump sources at different pump wavelengths if an optical amplification over a larger bandwidth is desired.

The coupling unit 11 can be designed in the form of a wavelength-selective coupling unit. In this manner, it is possible to couple the pump power at the pump wavelength practically without appreciable losses into the transmission line 9. Conversely, the desired WDM signal, which is at higher wavelengths compared to the pump wavelength or wavelengths, can be transmitted practically free from losses to the WDM receiver unit via the coupling site of the coupling unit 11. Thus, in both signal paths, at most, low insertion losses are to be expected.

In addition, the optical amplifier unit 7 comprises a coupling unit 15 which is located in the signal path between the coupling unit 11 and the input of the WDM receiver unit 5. The coupling unit 15 may be designed in the form of a simple wavelength-independent splitter. It serves to branch off a specific fraction of the power, for example, only a few percent, from the signal present at the input 15a of the coupling unit 15 and to feed it to detector 17. Detector 17 generates an electrical signal that is dependent on the power of the optical signal fed to said detector and feeds said signal to a control unit 19. The control unit 19 serves to control the pump source 13 and optionally to manage other tasks assigned to it.

The optical amplifier unit 7 makes it possible to monitor the transmission line 9 in the manner outlined below:

The control unit 19 controls the pump source 13, in particular on activation of the optical amplifier unit 7, initially in such a manner that a pump power Pₚ is coupled into the transmission line 9, which pump power is so low that nonlinear optical effects do not yet occur. By means of detector 17, the control unit 19 checks whether a signal with a power larger than a preset threshold value occurs in the signal path toward the optical receiver unit 5. Such a signal can only be generated when a disturbed region, at which a reflection of the pump signal occurs, is present along the path of the transmission line 9, between port 11a for coupling the pump power into the transmission line 9 and the output for the WDM signal of the WDM transmitter unit 3. In this case, the control unit 19 generates an error signal and turns the pump source 13 off. An increase in the power of the pump source 13 is avoided.

The explanation above applies to cases in which the reflected pump light (at least a detectable power component thereof) can reach coupling unit 15 via coupling unit 11. If coupling unit 11 is designed in the form of a wavelength-sensitive coupling unit, however, the reflected signal is fed toward pump source 13. In this case, an additional coupling unit 18 is required, which at least partially decouples the reflected light and feeds it to an additional detector 20 (these components are shown as broken lines in FIG. 1). Coupling unit 18 can be designed, for example, in the form of an insulator and can decouple any optical power toward the pump source toward detector 20 [sic]. The signal of detector 20 is fed to control unit 19, which performs a signal analysis according to the method described above for the signal of detector 17.

However, since interruptions or disturbed areas in the transmission line 9 can also be of such a nature that no reflections occur (such as is the case along completely irregular or oblique end faces of the transmission fiber), if control unit 19 detects no reflection signal after performing the previously explained first step, it controls the pump source 13 to generate a pump power which is high enough that the Raman effect occurs in the transmission line 9. In this case, an ASE signal with power P_{ASE} is generated within the effective length (see below) of the transmission line 9, which ASE signal is fed via coupling unit 11 to coupling unit 15 and detector 17. If the control unit 9 determines on the basis of the detector signal fed to it that the ASE signal was detected as having power P_{ASE} that is lower than a preset threshold value, the control unit 19 assumes that the transmission line 9 is disturbed or interrupted.

In this case, the control unit 19 immediately turns off the pump source 13. In the next step, the control unit 19 can immediately increase the pump power 13 to the maximum value desired to operate the transmission line. In this case again, the power of the ASE signal can be detected by detector 17 for the pump power that is now higher and can be compared to an associated threshold value. If this power P_{ASE} is also within the range of the present threshold value or within permissible tolerance limits, the control unit 19 can release an enabling signal S to a higher-level control unit which subsequently appropriately controls the WDM transmitter unit 3 and the WDM receiver unit 5.

The pump power Pₚ can also be gradually increased step by step or it can be increased continuously. In this case, the control unit 19 can detect power P_{ASE}, which is dependent on pump power Pₚ, and compare it to the associated threshold values that depend on power Pₚ or with the range of a threshold value. In this case, the enabling signal S can be generated only when it is determined for all values of power P_{ASE} that these correspond to the relevant preset threshold value or are within permissible tolerance limits.

Preferably, control unit 19 is designed so that it controls the pump source 13 for starting up the optical amplifier unit 7 such that a modulated pump signal is generated, preferably amplitude-modulated. In this manner, control unit 19 can phase-sensitively detect the ASE signal which in this case is, of course, also modulated. For this purpose, the control unit can comprise an integrated lock-in amplifier (said lock-in amplification can, of course, also be implemented in the form of an independent component). This allows a highly accurate detection of even a very small power P_{ASE}.

FIG. 2 is a schematic representation of the spectrum of the signal that is carried in the transmission line 9 during normal operation. In the practical example shown in FIG. 2, the pump source 13 comprises transmitting elements for two pump wavelengths λp₁ and λp₂. In addition, FIG. 2 shows a WDM signal comprising component signals at wavelengths λ₁-λ₄. It goes without saying that in FIG. 2, a different scaling for power Pₚ has to be assumed for the power at pump wavelengths λp₁, λp₂ than for the power of the component signals of the WDM signal. Furthermore, the response of the optical amplification gₒₚₜ is shown in FIG. 2 as a broken line for which a logarithmic scale must be used.

FIG. 2 also clearly illustrates that the wavelengths λp₁, λp₂ must be selected in such a way that a sufficient, preferably a uniform optical amplification is ensured across the entire bandwidth of the component signals at the wavelengths λp₁ to λp₄.

FIG. 3 illustrate the response of the pump power Pₚ and the response of the useful optical power Pₙ along the length L of the transmission line 9 in FIG. 1. As FIG. 3 shows, an optical amplification of power Pₙ of the wanted signal exists because of the high pump power Pₚ in the region of the effective length L_{eff}. Because of the high pump power, however, the ASE signal to be analyzed according to the present invention is also generated throughout the effective length L_{eff}. According to the present invention, it is therefore possible to monitor at least the transmission line 9 over a length starting from the point at which the pump power is coupled in up to the effective length L_{eff}.

1. A method for monitoring an optical transmission line by means of an optical amplifier, in particular a Raman amplifier,
(a) wherein the pump power (Pₚ) generated by a pump source (13) of the optical amplifier (7) is coupled into the optical transmission line (9),
(2) wherein the power (P_{ASE}) of the ASE (Amplified Spontaneous Emission) signal generated by the pump power (Pₚ) in the transmission line (9) and fed back toward the optical amplifier (7) is detected, and
(c) wherein an error signal is generated when the power (P_{ASE}) of the detected ASE signal falls below a preset threshold value.

2. The method as in claim 1, characterized in that, in the event of an error signal, the pump source (13) is deactivated.

3. The method as in claim 1 or 2, characterized in that, in the event of an error signal, an error message and/or an operator call is generated.

4. The method as in any one of the preceding claims, characterized in that the pump power (Pₚ) is increased continuously or gradually step by step, and that the ASE signal is detected continuously and/or gradually step by step and compared at each incremental step to a threshold value that corresponds to the relevant pump power (Pₚ).

5. The method as in claim 4, characterized in that an error signal is generated if, for the values detected for several or for all different values of the pump power (Pₚ), the power (P_{ASE}) of the associated ASE signal drops below a relevant threshold value.

6. The method as in any one of the preceding claims, characterized in that, in an upstream process step, the pump power (Pₚ) is set to a value at which nonlinear optical effects do not yet occur in the transmission line (9) and that, instead of the power (P_{ASE}) of the ASE signal, the power of a signal component potentially reflected in the transmission line (9) is detected and that a reflection error signal is generated when the power of a detected reflected error signal exceeds a preset threshold value.

7. The method as in any one of the preceding claims, characterized in that, in the phase of starting up the optical amplifier (7), the pump power (Pₚ) is modulated, in particular amplitude-modulated, and that the ASE signal is detected in a phase-sensitive manner.

8. The method as in claim 7, characterized in that the modulation of the pump power (Pₚ) takes place in such a manner that the time weighted average of the pump power is below a preset limit.

9. The method as in any one of the preceding claims, characterized in that the pump power (Pₚ) is coupled into the transmission line (9) in a direction opposite that of transmission of the signal that is to be optically amplified.

10. The method as in any one of the preceding claims, characterized in that the pump power-dependent threshold value, the various pump power-dependent threshold values, or the pump power-dependent range of threshold values for the power (P_{ASE}) of the ASE signal are determined in a calibration process, with the value or values for the power (P_{ASE}) of the ASE signal being detected as a function of the pump power (Pₚ) and preferably stored when the transmission line (9) is connected and intact.

11. An optical amplifier, in particular an optical Raman amplifier,
(a) with a coupling unit (11) for coupling the pump power (Pₚ) of an optical pump source (13) into an optical transmission line (9),
(b) with a coupling unit (15) for decoupling the ASE (Amplified Spontaneous Emission) signal generated by the pump power (Pₚ) in the transmission line (9) and fed back toward optical amplifier,
(c) with a detector unit (17) for detecting the decoupled ASE signal, and
(d) with a control unit (19) for controlling the pump source (13) and which takes a signal that has been fed to it by the detector unit (17) and which corresponds to the power (P_{ASE}) of the detected ASE signal and compares it to a preset threshold value and generates an error signal when said signal falls below the threshold value.

12. The optical amplifier as in claim 11, characterized in that the coupling unit (11) for coupling in the pump power (Pₚ) is designed in the form of a wavelength-sensitive coupling unit, with wavelengths which are higher by a preset value than the pump wavelength with a low loss being substantially assigned to the optical path for a wanted signal to be transmitted along the transmission line (9) and with lower wavelengths with a low loss being assigned to the branching-off arm for coupling in the pump power (Pₚ).

13. The optical amplifier as in claim 11 or 12, characterized in that the coupling unit (15) for decoupling the ASE signal is substantially designed in the form of a wavelength-independent splitter which only decouples a small portion of the power of the ASE signal.

14. The optical amplifier as in any one of claims 11-13, characterized in that the control unit (19) carries out the process steps according to any one of claims 2-10.
